(19) United States
(12) Patent Application Publication
(10) Pub. No.: US 2018/0237286 A1
(43) Pub. Date: Aug. 23, 2018

(54) TOOTHPASTE TRANSFER DEVICE AND METHOD

(71) Applicants: Michael Seiba, McAllen, TX (US); Joseph Anthony Seiba, McAllen, TX (US)

(72) Inventors: Michael Seiba, McAllen, TX (US); Joseph Anthony Seiba, McAllen, TX (US)

(21) Appl. No.: 15/891,152

(22) Filed: Feb. 7, 2018

Related U.S. Application Data
(60) Provisional application No. 62/462,613, filed on Feb. 23, 2017.

(51) Int. Cl. B67D 7/02; B65B 3/16

(52) U.S. Cl. CPC B67D 7/0288; B65B 3/16; B67D 7/0216

(57) ABSTRACT

A toothpaste transfer device for transferring toothpaste from a larger home-size toothpaste tube to a smaller travel-size toothpaste tube, enabling one to fill and refill travel-size toothpaste tubes.

### FIELD OF THE INVENTION

This disclosure relates to devices for transferring toothpaste from a larger home-size toothpaste tube to a smaller travel-size toothpaste tube.

### BACKGROUND OF THE INVENTION

Travel-size toothpastes have been around for many years. A problem with the travel-size toothpastes is that they do not hold much toothpaste. When packing for travel, often a travel-size toothpaste has some toothpaste, but not enough toothpaste for the duration of the trip. Another problem is that the Federal Aviation Administration (FAA) requires that toothpaste be in containers that are 3.4 ounces (100 ml) or less for carry on. As a result, larger-size toothpastes can not be carried on during a flight.

### SUMMARY OF THE INVENTION

An aspect of the present invention involves a toothpaste transfer device for transferring toothpaste from a larger home-size toothpaste tube to a smaller travel-size toothpaste tube (i.e., enables one to refill travel-size toothpaste tubes).

Another aspect of the invention involves a toothpaste transfer device for transferring toothpaste from a delivery toothpaste tube to a receiving toothpaste tube, the delivery toothpaste tube and the receiving toothpaste tube each including an externally threaded end with an interior surface, comprising a first nozzle with an outer surface and a lumen; a second nozzle with an outer surface and a lumen in communication with the lumen of the first nozzle, wherein the first nozzle is configured to be received at least partially within the externally threaded end of the delivery toothpaste tube so that the outer surface of the first nozzle abuts or is adjacent to the interior surface of the externally threaded end of the delivery toothpaste tube, and the second nozzle is configured to be received at least partially within the externally threaded end of the receiving toothpaste tube so that the outer surface of the second nozzle abuts or is adjacent to the interior surface of the externally threaded end of the receiving toothpaste tube whereby upon squeezing the delivery toothpaste tube toothpaste in the delivery toothpaste tube is transferred through the lumen of the first nozzle and the lumen of the second nozzle and into the receiving toothpaste tube.

One or more implementations of the aspect immediately above include one or more of the following: the first nozzle and the second nozzle are funnel shaped so that the outer surfaces of the first nozzle and the second nozzle are inclined; the first nozzle and the second nozzle form a cannula body, and the lumen of the first nozzle and the lumen of the second nozzle forming a combined lumen there through; the toothpaste transfer device includes a disc disposed between the first nozzle and the second nozzle; and/or the toothpaste transfer device includes a longitudinal center and a central disc at the longitudinal center, and the first nozzle and the second nozzle extend outwardly away from each other from the central disc; the circular disc includes spaces holes therein.

Another aspect of the invention involves a method of using the toothpaste transfer device described in the above aspect comprising disposing the first nozzle at least partially within the externally threaded end of the delivery toothpaste tube so that the outer surface of the first nozzle abuts or is adjacent to the interior surface of the externally threaded end of the delivery toothpaste tube; disposing the second nozzle at least partially within the externally threaded end of the receiving toothpaste tube so that the outer surface of the second nozzle abuts or is adjacent to the interior surface of the externally threaded end of the receiving toothpaste tube; squeezing the delivery toothpaste tube whereby toothpaste in the delivery toothpaste tube is transferred through the lumen of the first nozzle and the lumen of the second nozzle, and into the receiving toothpaste tube.

One or more implementations of the aspect immediately above include one or more of the following: the first nozzle and the second nozzle are funnel shaped so that the outer surfaces of the first nozzle and the second nozzle are inclined, and the method includes disposing the funnel shaped first nozzle at least partially within the externally threaded end of the delivery toothpaste tube so that the outer surface of the funnel shaped first nozzle abuts or is adjacent to the interior surface of the externally threaded end of the delivery toothpaste tube; disposing the funnel shaped second nozzle at least partially within the externally threaded end of the receiving toothpaste tube so that the outer surface of the funnel shaped second nozzle abuts or is adjacent to the interior surface of the externally threaded end of the receiving toothpaste tube; squeezing the delivery toothpaste tube whereby toothpaste in the delivery toothpaste tube is transferred through the lumen of the funnel shaped first nozzle and the lumen of the funnel shaped second nozzle, and into the receiving toothpaste tube; the first nozzle and the second nozzle form a cannula body, the lumen of the first nozzle and the lumen of the second nozzle forming a combined lumen there through, and squeezing the delivery toothpaste tube includes squeezing the delivery toothpaste tube whereby toothpaste in the delivery toothpaste tube is transferred through the combined lumen of the cannula body, and into the receiving toothpaste tube; the toothpaste transfer device includes a disc disposed between the first nozzle and the second nozzle, and the method further includes disposing the first nozzle and the second nozzle so that the externally threaded ends of the receiving toothpaste tube and the delivery toothpaste tube abut the disc; the toothpaste transfer device includes a longitudinal center and a central disc at the longitudinal center, the first nozzle and the second nozzle extend outwardly away from each other from the central disc, and the method further includes disposing the first nozzle and the second nozzle so that the externally threaded ends of the receiving toothpaste tube and the delivery toothpaste tube abut the central disc; and/or the circular disc includes spaces holes therein.

### BRIEF DESCRIPTION OF THE DRAWINGS

FIG. 1 is a perspective view of an embodiment of a toothpaste transfer device shown being applied to the externally threaded ends of a larger home-size toothpaste tube and a smaller travel-size toothpaste tube;

FIG. 2 is a cross-sectional view of toothpaste transfer device of FIG. 1 coupling the externally threaded ends of a larger home-size toothpaste tube and a smaller travel-size toothpaste tube;

FIG. 3 is a perspective view of the toothpaste transfer device of FIG. 1;

FIG. 4 is an end view of the toothpaste transfer device of FIG. 1;

FIG. 5 is a perspective view of another embodiment of a toothpaste transfer device shown being applied internally to the externally threaded ends of a first (e.g., home-size) toothpaste tube and a second (e.g., travel-size) toothpaste tube;

FIG. 6 is a cross-sectional view of toothpaste transfer device of FIG. 5 coupling the externally threaded ends, from inside the externally threaded ends, of the first toothpaste tube and the second toothpaste tube;

FIG. 7 is a perspective view of the toothpaste transfer device of FIG. 5;

FIG. 8 is an end view of the toothpaste transfer device of FIG. 5;

FIG. 9 is a perspective view of another embodiment of the toothpaste transfer device.

### DETAILED DESCRIPTION OF PREFERRED EMBODIMENTS

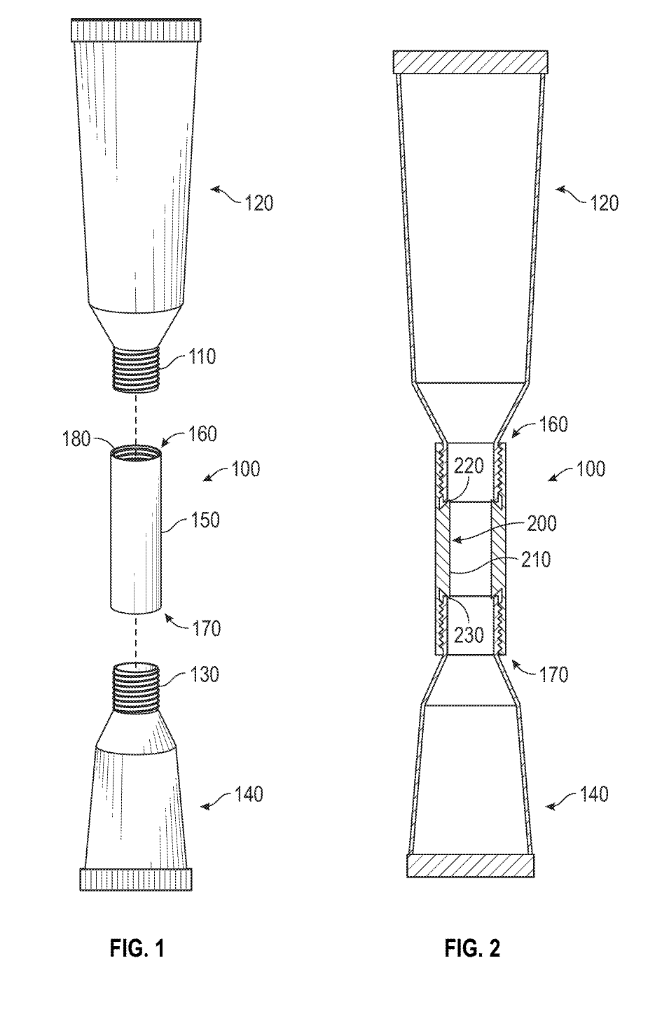

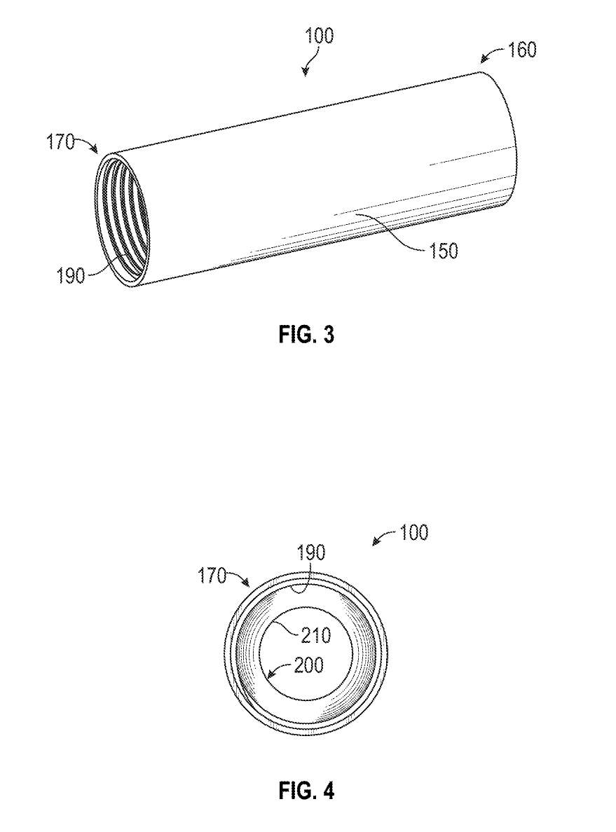

With reference initially to FIGS. 1-4, an embodiment of a toothpaste transfer device 100 that couples an externally threaded end 110 of a larger home-size toothpaste tube 120 with an externally threaded end 130 of a smaller travel-size toothpaste tube 140 will be described. The toothpaste transfer device 100 enables one to transfer toothpaste from the larger home-size toothpaste tube 120 to the smaller travel-size toothpaste tube 140, allowing one to refill travel-size toothpaste tubes 140.

The toothpaste transfer device 100 includes a cylindrical body 150 including a first end 160 and an opposite second end 170. The first end 160 includes interior threads 180 that rotatably receive the externally threaded end 110 of a larger home-size toothpaste tube 120. The second end 170 includes interior threads 190 that rotatably receive the externally threaded end 130 of the smaller travel-size toothpaste tube 140.

In a longitudinal central portion in the cylindrical body 150, between the interior threads 180 of the first end 160 and the interior ends 190 of the second end 170, a cannula 200 is disposed. The cannula 200 includes a smooth interior cylindrical surface 210 and terminates in opposite open frustoconical ends 220, 230, which create(s) air tight seal.

In use, to fill/refill the smaller travel-size toothpaste tube 140 with toothpaste from the larger home-size toothpaste tube 120, the end caps of the toothpaste tubes 120, 140 are first removed from the externally threaded ends 110, 130. The externally threaded ends 110, 130 are then screwed into the interiorly threaded ends 160, 170 of the toothpaste transfer device 100 (and/or the interiorly threaded ends 160, 170 of the toothpaste transfer device 100 are screwed onto the externally threaded ends 110, 130 of the toothpaste tubes 120, 140. Before coupling the externally threaded ends 110, 130 of the toothpaste tubes 120, 140 together with the toothpaste transfer device 100, one may squeeze the air out of the smaller travel-size toothpaste tube 140. Once the toothpaste transfer device 100 is coupled to the externally threaded ends 110, 130 of the toothpaste tubes 120, 140, as shown in FIG. 2, the body of the larger home-size toothpaste tube 120 is squeezed, causing toothpaste to be transferred from the larger home-size toothpaste tube 120, through the cannula 200 of the toothpaste transfer device 100, and into the smaller travel-size toothpaste tube 140, filling/refilling the smaller travel-size toothpaste tube 140 with toothpaste from the larger home-size toothpaste tube 120. When done filling/refilling the smaller travel-size toothpaste tube 140, the end caps of the toothpaste tubes 120, 140 are then applied onto the externally threaded ends 110, 130.

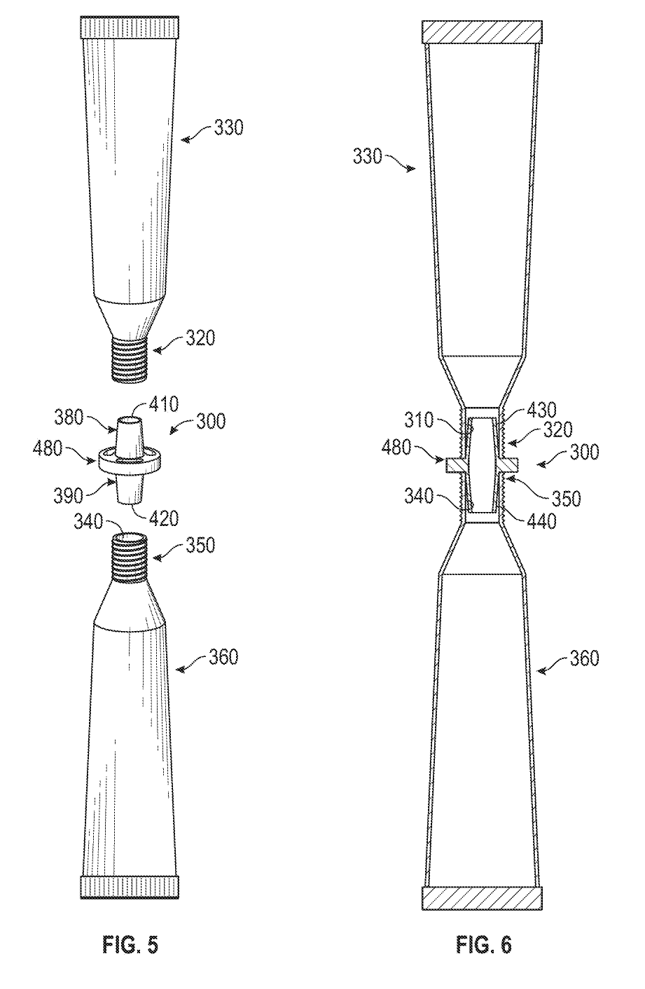

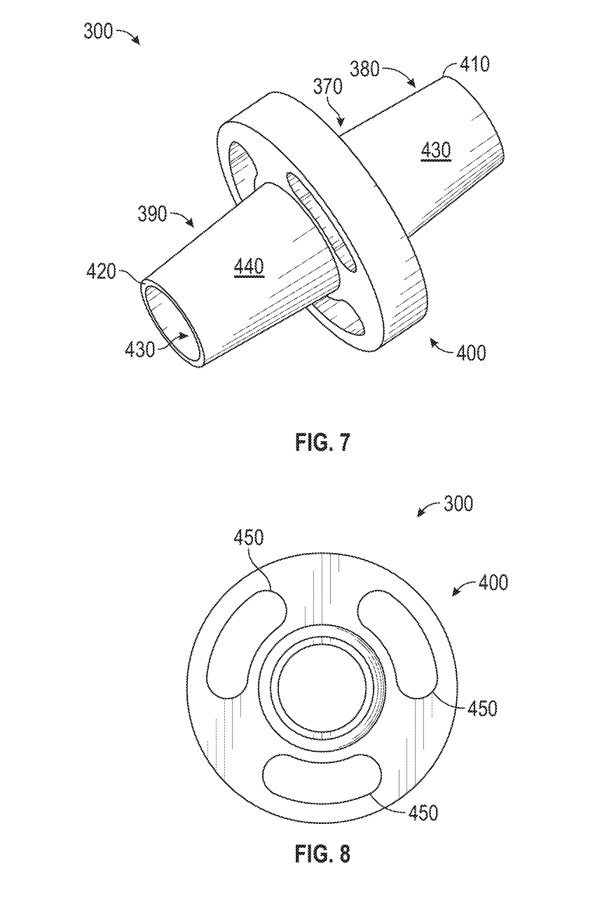

With reference to FIGS. 5-8, another embodiment of a toothpaste transfer device 300 that couples an inner surface 310 of an externally threaded end 320 of a delivery or first toothpaste tube 330 with an inner surface 340 of an externally threaded end 350 of a receiving or second toothpaste tube 360 will be described. Although not shown to scale, the delivery/first toothpaste tube 330 may be a larger home-size toothpaste tube and the receiving or second toothpaste tube 360 may be a smaller travel-size toothpaste tube such that the toothpaste transfer device 300 enables one to transfer toothpaste from the larger home-size toothpaste tube 330 to the smaller travel-size toothpaste tube 360, allowing one to refill travel-size toothpaste tubes 360.

The toothpaste transfer device 300 includes a cannula body 370 including a first funneled or frustoconical nozzle 380 with a first lumen and a second opposite, co-axial funneled or frustoconical nozzle 390 with a second lumen. Surrounding a periphery of the cannula body 370 is a fixed central disc 400 at a longitudinal center of the cannula body 370 relative to opposite ends 410, 420 of the nozzles 380, 390. The first nozzle 380 and the second nozzle 390 extend outwardly away from each other from the central disc 400. The nozzles 380, 390 have inclined outer surfaces 430, 440 that taper inwardly progressing from the central disc 400 to the ends 410, 420 of the nozzles 380, 390. The central disc 400 includes three evenly circumferentially spaced, kidney-shaped holes 450 extending vertically through the disc 400. When the toothpaste transfer device 300 is used to transfer toothpaste between the delivery toothpaste tube 330 and the receiving toothpaste tube 360, the central disc 400 separates the two toothpaste tubes 330, 360 and prevents the cannula body 370 from sliding and becoming accidentally entirely inserted into the toothpaste tube 330, 360.

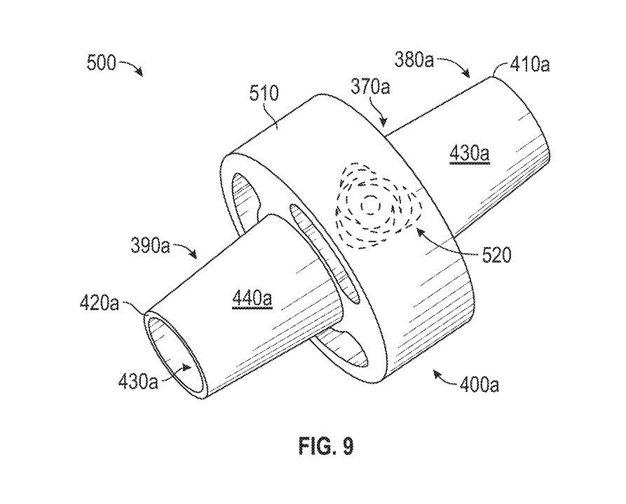

With reference to FIG. 9, another embodiment of a toothpaste transfer device 500 that couples an inner surface 310 of an externally threaded end 320 of a delivery or first toothpaste tube 330 with an inner surface 340 of an externally threaded end 350 of a receiving or second toothpaste tube 360 will be described. Similar elements to those shown in FIGS. 5-8 are shown with the same reference number, but with an “a” suffix, and are not described further. The toothpaste transfer device 500 shown in FIG. 9 is similar to the toothpaste transfer device 300 shown in FIGS. 5-8, except the central disc 400 is thicker, creating a periphery 510 with a large enough peripheral surface area to include an indicia (e.g., company logo, trademark, design, etc.) 520 thereon for marketing purposes.

In use, to fill/refill the receiving toothpaste tube 360 with toothpaste from the delivery toothpaste tube 330, the end caps of the toothpaste tubes 330, 360 are first removed from the externally threaded ends 320, 350. The nozzle 380 of the toothpaste transfer device 300 is inserted into the externally threaded end 320 of the delivery toothpaste tube 330 so that the external surface 430 of the nozzle 380 contacts and/or is adjacent to the inner surface 310 of the externally threaded end 320 of the delivery toothpaste tube 330. The externally threaded end 350 of the receiving toothpaste tube 360 is then inserted onto the opposite nozzle 390 of the toothpaste transfer device 300 so that the external surface 440 of the nozzle 390 contacts and/or is adjacent to the inner surface 340 of the externally threaded end 350 of the receiving toothpaste tube 360. Alternatively, the nozzle 390 of the toothpaste transfer device 300 may first be inserted into the externally threaded end 350 of the receiving toothpaste tube 360, followed by the externally threaded end 320 of the delivery toothpaste tube 330 being inserted onto the nozzle 380 of the toothpaste transfer device 300. Before coupling the ends 320, 350 of the toothpaste tubes 330, 360 together with the toothpaste transfer device 300, one may squeeze the air out of the receiving toothpaste tube 360. Once the toothpaste transfer device 300 is in place, as shown in FIG. 6, the body of the delivery toothpaste tube 330 is squeezed, causing toothpaste to be transferred from the delivery toothpaste tube 330, through the cylindrical lumen 430 of the cannula body 370 of the toothpaste transfer device 300, and into the receiving toothpaste tube 360, filling/refilling the receiving toothpaste tube 360 with toothpaste from the delivery toothpaste tube 330. When done filling/refilling the receiving toothpaste tube 140, the end caps of the toothpaste tubes 330, 360 are then applied onto the externally threaded ends 320, 350.

Advantages of the toothpaste transfer device 100, 300, 500 are:

1. Is environmentally friendly because it reduces the number of disposable travel-size toothpaste tubes that end up in landfills;

2. Less cumbersome transfer of contents from one compartment to another;

3. Less air transfer from one compartment to another;

4. Easier to carry due to compact design;

5. Better sealing mechanism, hence no leaks and less waste of material during transfer; and

6. Less chance of breaking and wear and tear since there is no threading mechanism.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in any following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

We claim:

1. A toothpaste transfer device for transferring toothpaste from a delivery toothpaste tube to a receiving toothpaste tube, the delivery toothpaste tube and the receiving toothpaste tube each including an externally threaded end with an interior surface, comprising:
a first nozzle with an outer surface and a lumen;
a second nozzle with an outer surface and a lumen in communication with the lumen of the first nozzle,
wherein the first nozzle is configured to be received at least partially within the externally threaded end of the delivery toothpaste tube so that the outer surface of the first nozzle abuts or is adjacent to the interior surface of the externally threaded end of the delivery toothpaste tube, and the second nozzle is configured to be received at least partially within the externally threaded end of the receiving toothpaste tube so that the outer surface of the second nozzle abuts or is adjacent to the interior surface of the externally threaded end of the receiving toothpaste tube whereby upon squeezing the delivery toothpaste tube toothpaste in the delivery toothpaste tube is transferred through the lumen of the first nozzle and the lumen of the second nozzle and into the receiving toothpaste tube.

2. The toothpaste transfer device of claim 1, wherein the first nozzle and the second nozzle are funnel shaped so that the outer surfaces of the first nozzle and the second nozzle are inclined.

3. The toothpaste transfer device of claim 2, wherein the first nozzle and the second nozzle form a cannula body, and the lumen of the first nozzle and the lumen of the second nozzle forming a combined lumen there through.

4. The toothpaste transfer device of claim 1, wherein the toothpaste transfer device includes a disc disposed between the first nozzle and the second nozzle.

5. The toothpaste transfer device of claim 4, wherein the disc includes a periphery having a peripheral surface area with an indicia thereon.

6. The toothpaste transfer device of claim 1, wherein the toothpaste transfer device includes a longitudinal center and a central disc at the longitudinal center, and the first nozzle and the second nozzle extend outwardly away from each other from the central disc.

7. The toothpaste transfer device of claim 5, wherein the disc includes spaces holes therein.

8. A method of using the toothpaste transfer device of claim 1, comprising: disposing the first nozzle at least partially within the externally threaded end of the delivery toothpaste tube so that the outer surface of the first nozzle abuts or is adjacent to the interior surface of the externally threaded end of the delivery toothpaste tube;
disposing the second nozzle at least partially within the externally threaded end of the receiving toothpaste tube so that the outer surface of the second nozzle abuts or is adjacent to the interior surface of the externally threaded end of the receiving toothpaste tube;
squeezing the delivery toothpaste tube whereby toothpaste in the delivery toothpaste tube is transferred through the lumen of the first nozzle and the lumen of the second nozzle, and into the receiving toothpaste tube.

9. The method claim 8, wherein the first nozzle and the second nozzle are funnel shaped so that the outer surfaces of the first nozzle and the second nozzle are inclined, and the method includes disposing the funnel shaped first nozzle at least partially within the externally threaded end of the delivery toothpaste tube so that the outer surface of the funnel shaped first nozzle abuts or is adjacent to the interior surface of the externally threaded end of the delivery toothpaste tube; disposing the funnel shaped second nozzle at least partially within the externally threaded end of the receiving toothpaste tube so that the outer surface of the funnel shaped second nozzle abuts or is adjacent to the interior surface of the externally threaded end of the receiving toothpaste tube; squeezing the delivery toothpaste tube whereby toothpaste in the delivery toothpaste tube is transferred through the lumen of the funnel shaped first nozzle and the lumen of the funnel shaped second nozzle, and into the receiving toothpaste tube.

10. The method of claim 9, wherein the first nozzle and the second nozzle form a cannula body, the lumen of the first nozzle and the lumen of the second nozzle forming a combined lumen there through, and squeezing the delivery toothpaste tube includes squeezing the delivery toothpaste tube whereby toothpaste in the delivery toothpaste tube is transferred through the combined lumen of the cannula body, and into the receiving toothpaste tube.

11. The method of claim 8, wherein the toothpaste transfer device includes a disc disposed between the first nozzle and the second nozzle, and the method further includes disposing the first nozzle and the second nozzle so that the externally threaded ends of the receiving toothpaste tube and the delivery toothpaste tube abut the disc.

12. The method of claim 8, wherein the toothpaste transfer device includes a longitudinal center and a central disc at the longitudinal center, the first nozzle and the second nozzle extend outwardly away from each other from the central disc, and the method further includes disposing the first nozzle and the second nozzle so that the externally threaded ends of the receiving toothpaste tube and the delivery toothpaste tube abut the central disc.
